(19) United States
(12) Patent Application Publication
(10) Pub. No.: US 2013/0346381 A1
(43) Pub. Date: Dec. 26, 2013

(54) Multimedia Real-Time Searching Platform (SKOOP)

(71) Applicant: Leslie Marcel Ottolenghi, Atlanta, GA (US)

(72) Inventor: Leslie Marcel Ottolenghi, Atlanta, GA (US)

(21) Appl. No.: 13/357,173

(22) Filed: Jan. 24, 2012

Related U.S. Application Data
(60) Provisional application No. 61/436,368, filed on Jan. 26, 2011.

(51) Int. Cl. G06F 17/30

(52) U.S. Cl. CPC G06F 17/30864
USPC 707/706

(57) ABSTRACT

SKOOP searches with an open architecture that allows the integration any existing resources and services and bring any search, 3^{rd}-party services, tools or message mining products into one place. Through a powerful rules-based approach, SKOOP uses a combination of semantic search and meta-search to leverage social relationships and to provide the most comprehensive insight into content and brand management across all of those locations. That wide reach allows SKOOP clients to see the various ways that their current or targeted consumers interact based on the digital location they are using with the ability to identify and follow content, people and actions across web, social media in order to give a comprehensive view into all major touch-points.

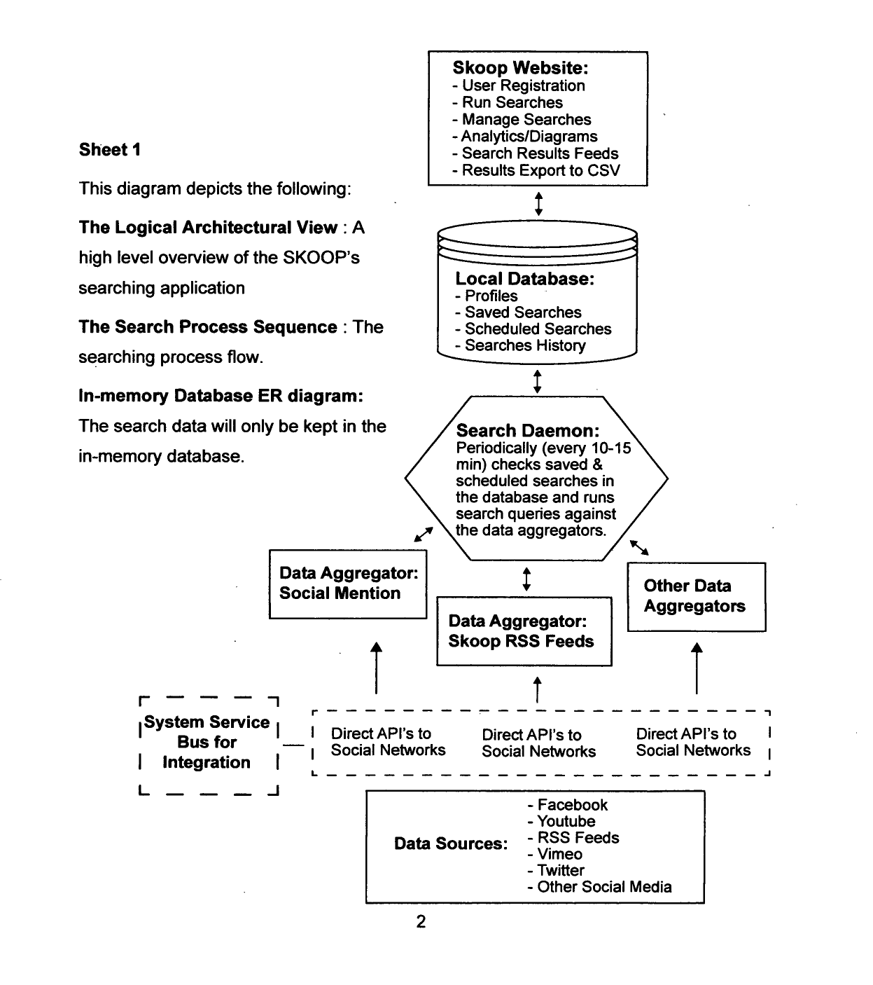

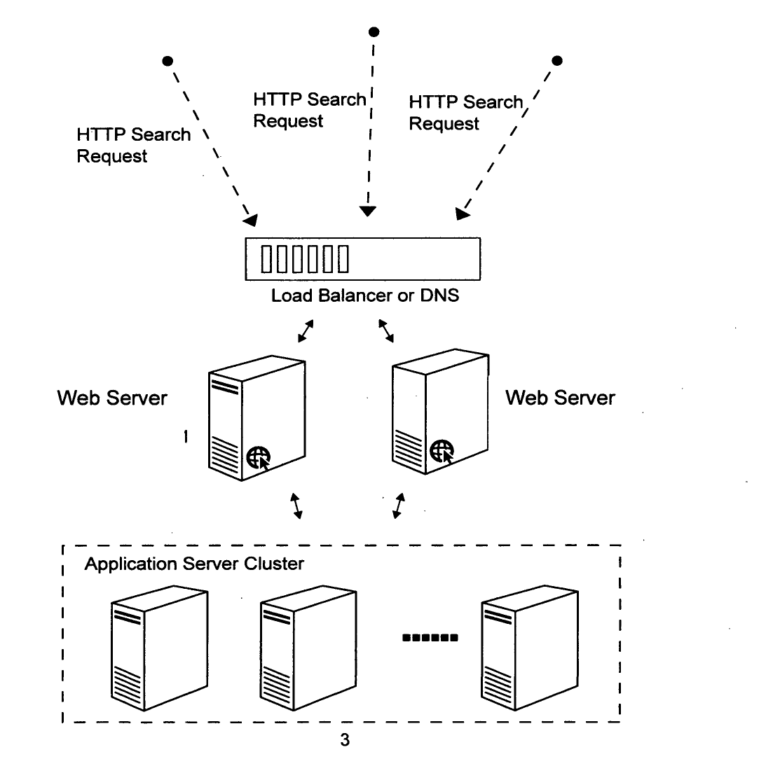

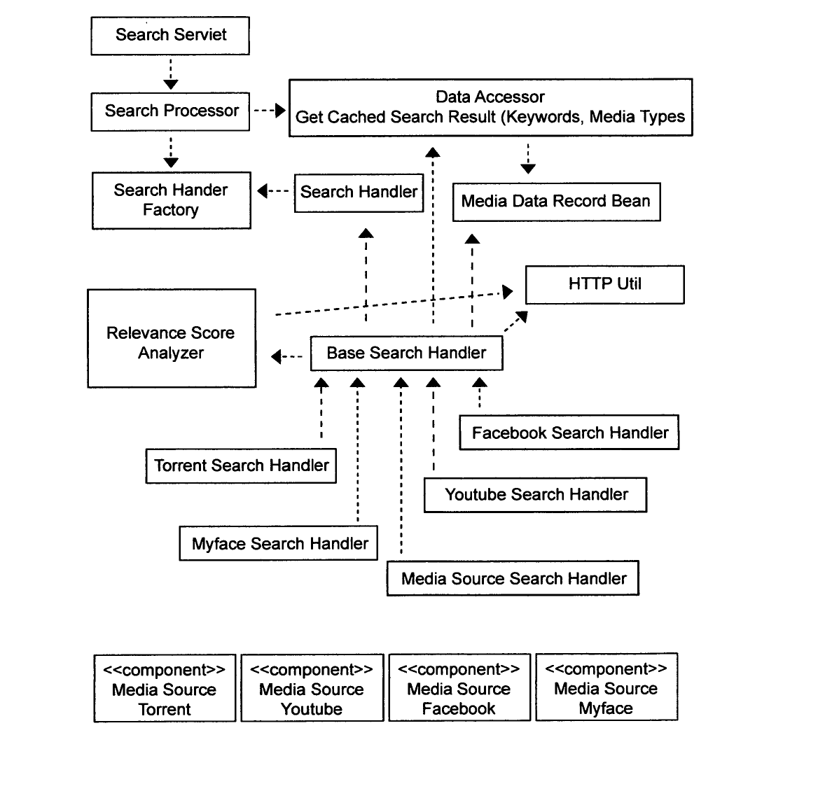

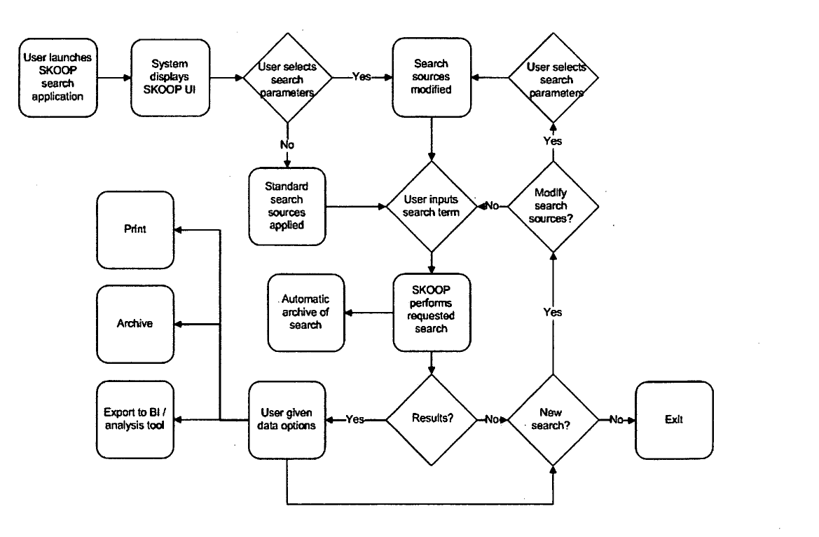

### CROSS REFERENCE TO RELATED APPLICATIONS

Provisional Patent Holder now claims the benefits to U.S. Provisional Patent Application No. 61/436,368, entitled Multimedia Real-Time Searching Platform, filed in Jan. 26, 2011.

### BACKGROUND OF THE INVENTION

1. Problem

Advances in social networks, communication tools, online media distribution, offline media connections and mobile devices allow anyone to share content in real-time.

While those activities generate valuable data, it is largely unstructured and its rapid growth makes targeted information, market intelligence and, therefore, effective strategies for business and revenue growth difficult for companies to develop and manage based on it.

2. Solution

Provide a simple tool to aggregate data sources and provide insight into how people connect to each other and share content within, and across, media platforms:
Centralize and simplify data gathering
Consolidate third-party search technologies, functions and innovations
Provide analytical support for both real-time and historical data
Support personalization—saved searches, single sign-on
Serve as a flexible engine for third-party business objectives and models

### BRIEF SUMMARY OF THE INVENTION

SKOOP is a powerful, flexible social search engine that aggregates information about social network profiles or users, and, therefore, provides insight into how people connect and share content across media platforms.

SKOOP provides immediate benefits for any content owner who seeks to discover the best audience to reach and monetize, including the ability to:
Monitor Content—Determine where your content or brand resides across any network
Find Audience—Determine the people that are interacting with your content or brand
Track Activity—See the actions, both direct and indirect, that your content drives

SKOOP accomplishes this with an open architecture that allows companies to easily integrate any of their existing resources and services and bring any search, 3^{rd}-party services, tools or message mining products into one place. Through a simple, yet powerful rules-based approach, SKOOP uses a combination of semantic search and meta-search to leverage social relationships and to provide the most comprehensive insight into content across all of those locations.

SKOOP can delve deep into those activities around content, people and brands to understand how the creators, consumers and influencers share information and perceptions. That wide reach allows SKOOP clients to see the various ways that their current or targeted consumers interact based on the digital location they are using.

With the ability to identify and follow content, people & actions across web, social media and decentralized networks like peer-to-peer networks, usenets and botnets, SKOOP gives a comprehensive view into all major touch-points of the brand relationship.

### Functional Categories

1. Compiling Existing Metrics
2. Support Relationship Mapping
3. Analytical Dashboard Visualization
4. Data Accumulation & Warehousing Resource Management
5. Relevance Control
6. Performance

### DETAILED DESCRIPTION OF THE INVENTION

### Introduction

### Audience

The intended audiences for this design specification are IT managers, software architects, software developers, and quality assurance engineers. It is intended to act as a technical reference for developers involved in the development of SKOOP's social search application.

### Intent

This document should serve as a living document that accompanies the development life cycle. It describes the design and the architecture of SKOOP's social search application. The design is expressed in sufficient detail so as to enable all the developers to understand the underlying architecture of SKOOP's search engine.

### Referenced Documents

The following documents were referenced in the construction of this document.

Social Search Functional Requirements.docx

### Terminology

Representational state transfer (REST)

JAX-RS, JSR-311, is a new JCP specification that provides a Java API for RESTful Web Services over the HTTP protocol.

MBean/Managed Bean: Managed Beans are particularly used in the Java Management Extensions technology.

They can be used for getting and setting applications configuration (pull), for collecting statistics (pull) (e.g. performance, resources usage, problems, . . . ) and notifying events (push) (e.g. faults, state changes).

ER diagram: Database entity and entity relationship diagram

### System Overview

SKOOP's search tool is a Video|Audio|Radio|TV Streaming search service. It provides a comprehensive and normalized search result by searching across various media sources. At run time, SKOOP's search engine will search 10 popular Torrent sites and top 5 social networking sites for the match keyword and specified media type(s). The searchable media types are listed below:

| Media Type | Description |
|---|---|
| AUDIO | MUSIC SOUND, RADIO CHANNEL |
| VIDEO | MUSIC VIDEO, MOVIE, TV |
| PHOTO | Photo Image |

The searching sites/sources are dynamically configurable. The configuration can be based on the media type, i.e. different media type or media type combination can be associated with a different set of searching sources.

The popular torrent sites can be reviewed at http://www.torrentscan.com/?torrent_stats.php.

Following are the 10 torrent sites we will be used as media sources for searching. Additional sites can be added later if required.
BTJunkie
SumoTorrent
IsoHunt
Mninova
ThePrivateBay
Demonoid
Tagoo
SeedPeer
Fenony
Torrentz

The five popular social networking sites for searching are listed below:
MyFace
youTube
buzznet
Truveo
Yahoo

SKOOP's search engine utilizes multi-thread programming technology to search most popular media sources simultaneously.

The search result data from various sources is normalized and a relevance score is calculated for each data record based on the occurrence of the Wikipedia term index. The term index is obtained at runtime from following RESTful Web Service interface.

http://cwf2.appspot.com/cwx/term/{keyword}

The aggregated data results from various sources are returned in a normalized data record format specified by SKOOP's search engine and sorted by the relevance score. The pagination through the aggregated search data result is also supported by the SKOOP's search engine.

For a better performance, in-memory database is used by SKOOP's search engine to caching and sorting the aggregated search data results from various sources.

Additional, a configuration and monitoring service is implemented to provide dynamic configuration change and monitoring system performance, health checking and provide search request statistics.

### Architectural Strategies and Design Consideration

### Constraints

Support old SKOOP's searching tool request and response specification.

### Architectural Strategies

The core search engine encapsulating all business logic can be implemented with POJOs. A thin communication layer wraps the core search engine provides the RESTful web service as external search interface.

Additional communication layer (such as SOAP Web Service . . . ) can also be easily added by extending a thin wrap on the core search engine.

The RESTful web service layer will be implemented with JBoss open source RESTful web service framework RESTEasy. The RESTEasy implements the JAX-RS specification that provides a Java API for RESTful Web Services over the HTTP protocol.

The SKOOP's search application will be deployed and running on JBoss application server. JBoss MBean can be implemented for dynamic configuration, and system monitoring.

### Performance

SKOOP's search engine executes runtime searching across various external media sources. It normalizes and aggregates all data records. The response data records are sorted based on calculated relevance score. The time used for this searching, consolidating result data, assign relevance score based on term index and sorting response data based on the relevance score is key concern for the successful implementation of the SKOOP's search engine. Following approaches are used to improve the searching performance.
Use JAVA multi-threaded programming technology to execute search simultaneously on all configured external media sources.
For each searching request to the external media source, a connecting and reading timeout need to be set to avoid a long waiting time.
For each media source searching, we need to control the returned search result size. If too many records are returned, only top records of a specified number will be used and processed by SKOOP's search engine.
In-memory database will be used for storing the search result data for processing and sorting. It will also provide search data cache with key value equals to keywords and search types combination. The pure JAVA HSQLDB will be used as the In-memory database. However it can be easily swapped with another in-memory DB or external DB with data source configuration change if necessary.

### Search Configuration

The search configuration is detailed in the Replacement Sheet, View 1.

### MBean Service for System Configuration and Monitoring

JMX managed bean is designed and implemented to getting and setting search application configuration, usage tracking and collecting statistics.

### Development Method

Test-driven approach will be used for this implementation, especially for the external media source integration. The media source handler class test case implementation is mandatory. JUnit test framework should be used for development unit test implementation.

Any tool will be used for automate build and generate release package.

### System Architecture

### Logical Architecture View

The diagram in the Replacement Sheet, Sheet 1 depicts a high level overview of the SKOOP's searching application.

### Deployment View

This section describes one or more physical server/network (hardware) configurations on which the software is deployed and run. It is view of Deployment Model. At a minimum for each configuration it should indicate the physical notes (Computers, CPUs) that execute the software and their interconnections (bus, LAN, point-to-point and so-on)

SKOOP's search engine is deployed using the standard J2EE packaging such as an Enterprise Archive (EAR)

The diagram in the Replacement Sheet, Sheet 2 depicts suggested hardware deployment for the SKOOP's searching application.

### Detail System Design

### Class Diagram

The UML class diagram in the Replacement Sheet, Sheet 3 depicts the classes of the system and their inter-relationships.

### In-Memory Database ER Diagram

The simple ER diagram in the Replacement Sheet, Sheet 1 depicts the in-memory database design. The search request and result data are stored in the table specified in the diagram. The search data will only be kept in the in-memory database for specific days configured by the system. A system purging process will be scheduled to run daily to purge the data.

### Search Process Sequence Diagram

The sequence diagram in the Replacement Sheet, Sheet 1 depicts the searching process flow.

### Search Interface

The SKOOP's searching application provides a HTTP based RESTful web service for searching.

Request

Following is the search request interface definition.

/searching/{vid}/{mediatypes}/keywords/{pagesize}/{pagenumber}

Vid: assigned search clientid. It identifies where the search request comes from

Mediatypes: search media type(s). Following is a list of valid media type values,
AUDIO
VIDEO
PHOTO
AUDIO, VIDEO
AUDIO, PHOTO
VIDEO, PHPTO
ALL
Profile

Keywords: searching keyword(s)

Pagesize: the number of search records return per searching request.

Pagenumber: page number.

It is also implemented to support the HTTP request/response specification of the previous SKOOP's search tool. /search?op=wfsvxml&VID={vid}&ukkeyword={keywords&uktype={mediatypes}&xml=<RESULTFORMAT>XML<RESULTFORMAT><PAGESIZE>{pagesize}</PAGESIZE><PAGENUM>{pagenumber}</PAGENUM>

Response

The search response is in the XML format specified as the following:

<?xml version=“1.0” encoding=“utf-8”?>
<Response Sid=“BAD936BAEEA7B74B0D4B2FB39A7D19C1”>
<Record Index=“0” Vid=“DC_DEMO” Mediatype=“music”
Source=“ArtistDirect”
Sourceicon=“http%3A%2F%2F63.216.80.203%2FSKOOP's%2FSite%2Fl
ogo_artistdirect.gif”>
<Title> </Title>
<Genre> </Genre>
<Viewurl> </Viewurl>
<Islive></Islive>
<Isstreaming>S</Isstreaming>
<Filetype></Filetype>
<Shortdescription></Shortdescription>
<Description></Description>
<Buyurl></Buyurl>
<Album></Album>
<Artist></Artist>
<Actor></Actor>
<Location City=“” State=“” Country=“” Countrycode=“” />
<Thumbmail></Thumbmail>
<Image></Image>
<Network>web</Network>
<Relevance>0</Relevance>
<RelatedInfo></RelatedInfo>
<Companyname>ARTISTdirect, Inc.</Companyname>
<Street1>1601 Cloverfield Blvd.</Street1>
<Street2>Ste. 400 South</Street2>
<City>Santa Monica</City>
<State>CA</State>
<Zip>90404</Zip>
<Country>US</Country>
<Address>ARTISTdirect, Inc., 1601 Cloverfield Blvd., Ste. 400 South,
Santa Monica, CA 90404, US</Address>
<Latitude>−8.98</Latitude>
<Longitude>−78.629997</Longitude>
<Profiler></Profiler>
<Profilerurl></Profilerurl>
</Record>
</Response>

| | |
|---|---|
| Response | Contains a series of records. Its element Sid |
| | is session id generated by the system |
| Record | A complete media record. It contains several |
| | elements; Index—record sequence |
| | Number, Vid—id assigned to you, Mediatype— |
| | media type of music, radio, TV, and |
| | Video, Source—source site where the record |
| | is retrieved, Sourceicon—logo of source site |
| Title | The title name of media |
| Genre | Genre of the record |
| Viewurl | url that offers the free view of the content. |
| Islive | Y—is live, N—is not, no value—cannot be |
| | determined. |
| Isstreaming | D—download, S—streaming data, U and |
| | empty value—cannot be determined |
| Filetype | File format type |
| Short | Brief description of record if available. |
| Description | |
| Description | Full description of the record if available. |
| Buyurl | url that requires fee charge or membership |
| Album | Music album name |
| Artist | Music artist name. |
| Actor | Movie actor name. |
| Location | Location of the item. It contains City, State, |
| | Country, and Country code and should not be |
| | Confused with vendor's address below. |
| Thumbnail | Thumbnail image link |
| Image | Image link of the media |
| Network | Define media source group. Web—from web |
| | portals. P2P—from P2P sources |
| Relevance | An integer value of content relevancy to the |
| | search request |
| Related Info | The related info to the search keyword |
| Company name | The company name of the site that returns |
| | item |
| Street1 | The street name of the vendor |
| Street2 | Additional street name of the vendor |
| City | City name of the vendor |
| State | State name if in US and Canada of the vendor |
| Zip | Zip code of the vendor |
| Country | Country code of the vendor |
| Address | Full address of the vendor |
| Latitude | Latitude coordinate of the vendor location |
| Longitude | Longitude coordinate of the vendor location |
| Profiler | The profiler's name or alias that associates |
| | with the item |
| Profilerurl | A link to the profiler page that associates with |
| | the item |

### Search Source Configuration

The search source is configured using XML file. The xsd schema definition for the search source xml is as the following:

<?xml version=“1.0” encoding=“UTF-8”?>
<xs:schema xmlns:xs=“http://www.w3.org/2001/XMLSchema”>
<xs:simpleType name=“mediaType”>

<xs:restriction base=“xs:string”>

<xs:enumeration value=“ALL”/>
<xs:enumeration value=“DEFAULT”/>
<xs:enumeration value=“MUSIC”/>
<xs:enumeration value=“VIDEO”/>
<xs:enumeration value=“PHOTO”/>
<xs:enumeration value=“VIDEOMUSIC”/>
<xs:enumeration value=“VIDEOPHOTO”/>
<xs:enumeration value=“MUSICPHOTO”/>

</xs:restriction>

</xs:simpleType>
<xs:complexType name=“searchHandlerType”>

<xs:sequence>

<xs:element name=“name” type=“xs:string”/>
<xs:element name=“handleClass” type=“xs:string”/>
<xs:element name=“maxRecordSize”

type=“xs:positiveInteger”/>

<xs:element name=“timeoutInSecond”

type=“xs:positiveInteger”/>

</xs:sequence>

</xs:complexType>
<xs:element name=“searchSource”>

<xs:complexType>
<xs:sequence>

<xs:element name=“searchHandler”

type=“searchHandlerType”

minOccurs=“1” maxOccurs=“15”></xs:element>

</xs:sequence>
<xs:attribute name=“searchType” type=“mediaType”/>
</xs:complexType>

</xs:element>
<xs:element name=“searchSources”>

<xs:complexType>

<xs:sequence>

<xs:element ref=“searchSource” minOccurs=“1”

maxOccurs=“8”/>

</xs:sequence>

</xs:complexType>

</xs:element>
</xs:schema>

A sample search source xml file is as the following:

```
<?xml version=“1.0” encoding=“UTF-8”?>
  <searchSource searchType=“DEFAULT”>
    <name>isohunt</name>
  <handlerClass>com.fuzebox.SKOOP′s.search.handler.HttpSearch
Handler</handlerClass>
      <maxRecordSize>20</maxRecordSize>
      <connectionTimeout>30</connectionTimeout>
      <readTimeout>30</readTimeout>
  <searchURL><![CDATA[http://isohunt.com/torrents/{keywords}?ihs
1=13&iho1=d&iht=1]]></searchURL>
      <searchSiteLogo>logo.jpg</searchSiteLogo>
  <responseParserClass>com.fuzebox.SKOOP′s.search.responsep
arser.IsoHuntResponseParser</responseParserClass>
    </searchHandlerInfo>
    <searchHandlerInfo>
      <name>MySpaceMusic</name>
  <handlerClass>com.fuzebox.SKOOP′s.search.handler.HttpSearch
Handler</handlerClass>
      <maxRecordSize>10</maxRecordSize>
      <connectionTimeout>30</connectionTimeout>
      <readTimeout>30</readTimeout>
  <searchURL><![CDATA[http://searchservice.myspace.com/index.c
fm?fuseaction=sitesearch.results&type=Music&qry={keywords}
&submit=Search]]></searchURL>
      <searchSiteLogo>logo.jpg</searchSiteLogo>
  <responseParserClass>com.fuzebox.SKOOP′s.search.responsep
arser.MyspaceMusicSearchResponseParser</responseParserClass>
    </searchHandlerInfo>
    ...
    ...
  </searchSource>
  <searchSource searchType=“VIDEO”>
    ...
    ...
  </searchSource>
...
    ...
</searchSources>
```

### Relevance Score Analyzer

The RelevanceScoreAnalyzer class is designed to assign the relevance score value for each record returned from the searching.

The Relevance score calculation is based on the searching keyword(s). For each keyword, System obtains term index using the following external RESTful web service:

http://cwf2.appspot.com/cwx/term/{keyword}

The relevance score is the count of the occurrence of the all term index in the record data.

### Search Result Caching/Sorting/Pagination

The search result data returned from the various external media sources are cached in the in-memory database. A database query is used to perform sorting on the relevance score and select a set of data records for the specified page number.

### Search Handler

MyFaceSearchHandler

Search URL

Video:

http://searchservice.myspace.com/index.cfm?fuseaction=sitesearch.result s&type=MySpaceTV&qry={keywords}

Following data elements are captured:

person, description, categories, title, streamURL

Music

http://searchservice.myspace.com/index.cfm?fuseaction=sitesearch.result s&qry={kevwords}&type=Music

Following data elements can be captured y parsing the return data:

Artist Name, Song Title and Album, streamURL.

IsoHuntSearchHandler

Search URL

VIDEO: http://isohunt.com/torrents/{kevword}?ihs1=13&iho1=d&iht=3

AUDIO: http://isohunt.com/torrents/{keyword}?ihs1=13&iho1=d&iht=1

ALL: http://isohunt.com/torrents/?ihq={keyword}

Data elements can be captured:

Title, file size, Streaming URL, lecher, seeds, number of comments and rating.

1. SKOOP is built as a framework that combines multiple systems with flexibility, stability and scalability. That architecture allows it to operate as either a platform or a stand-alone service.
This approach, rather than a closed-system that is dependent on a specific operating system, allows companies to leverage all available tools that support content touchpoints. Such a framework also supports an interactive dashboard for any web services, desktop applications and search engines, providing companies with far more flexibility and functionality than the single-purpose, proprietary, closed tools.
The SKOOP framework provides for methods of communication between, and integration of, any tools necessary for content, action and people.
As shown in the Replacement Sheet, View 1, such an approach leverages multiple supplier connections and establishes critical intellectual property through the rules of connection within and to the framework such as the:
Method of connecting data to content resources
Relevance algorithms for search
Method of data and content syndication to clients, partners and end-users
Method of accumulation, analysis and reporting of data, both internal & external
Dashboard-centric user interface to support multiple inputs and outputs
More specifically, some of the key components of the SKOOP framework, which expands on the single-purpose capabilities of real-time search engines (ex, One Riot, Scoopler), web-only research tools (ex. comScore, Radian 6) and non-interactive data platforms (ex, Compete, Google Analytics):
1) An open architecture that allows users to integrate any of their existing resources and services, whether public or private; internal or third party.
2) Ability to discover content across any network and multiple services with one account.
3) Ability to identify and follow brand discussions, content locations and content interactions across Web, social media, peer-to-peer networks, usenets and botnets to give a comprehensive view into all key touchpoints of content.
4) Ability to add any data streams to support customer intelligence in real-time.
5) A software-as-a-service solution that is operating system and browser agnostic does not require downloading any software or installing any hardware and can work seamlessly with legacy or enterprise software systems whether developed internally or licensed from a third-party vendor.
The SKOOP framework has a powerful method of connecting to data and content resources and to assign relevance weighting to the results regardless of the inputs.
It combines semantic search, meta-search and the ability to interrogate decentralized networks such as peer-to-peer networks, botnets and usenet communities, which are rich repositories of content, sources of security breeching systems and malware and popular methods of communication outside the traditional web, including social networks.
Comprehensive discovery means providing an accurate view of all content touch-points, which can occur both actively and passively between individuals and groups as well as through the distribution and sharing of content on both a one-to-one and one-to-many basis. As such the SKOOP framework has the ability to:
Search—Using a combination of semantic search, data syndication and dashboard technologies to leverage social relationships between terms, provide the most comprehensive set of relevant locations where content resides, whether in centralized or decentralized networks.
Communicate—Delve deep into the discussions around content to understand how the creators, consumers and influencers share information, content and perceptions.
Consolidate—Bring all Search activities, 3^{rd}-party services, tools, target locations and message mining into one place to get a comprehensive, yet time and cost efficient, understanding of content regardless of location, media type (online, offline, mobile) or communications platform.
With those 3 essential components in mind, two critical points of differentiation between the framework approach taken by SKOOP compared to single-purpose tools in the market include:
1. The method of loose coupling, or attaching the Discovery Engine to websites, decentralized peer-to-peer (P2P) Networks, botnets and other IP based systems, is automated, simple and faster than other products;
2. The depth of information parsing of web sites, P2P or other IP based systems and the capability to do meta search functions such as:
(i) Accepting a natural language query describing desired information;
(ii) Parsing a natural language query to extract terms relevant to the desired information;
(iii) Creating search data comprising at least two search candidates from the extracted terms in a form appropriate to each of at least one search engine, and transferring the created search data to each of at least one search engine to initiating a search;
(iv) Receiving search results comprising at least one list of information sources from each of at least one search engine, and removing redundancies from at least one list of information sources to obtain a reduced list of information sources;
(v) Retrieving complete copies of each information source in the reduced list;
(vi) Examining each retrieved complete copy relative to the at least two search candidates to determine a match ranking, therefore, by:
a. arranging each said complete copy into segments, each segment defining the contents of said document between at least three consecutive matches between said complete copy and any of said at least two search candidates;
b. examining each segment in said complete copy to determine a segment score comprising a score for each match between the contents of said complete copy and each search candidate, and weighting said segment score with respect to the length of said segment;
c. selecting at least two segments of said complete copy with the highest weighted segment scores from step (b);
d. for each selected segment, augmenting the segment to include the contents of said complete copy between the selected segment and an adjacent match and performing step (b) for each augmented segment to obtain an updated segment score;
e. while said updated segment score for an augmented segment is greater than said segment store, performing step (d);
f. selecting said augmented segment with the highest updated segment score from each said complete copy; and
g. ranking the selected augmented segments for each said complete copy according to said updated segment scores;
(vii) Selecting at least the highest ranked selected augmented segment for display to the user, and editing each highest ranked selected segment to form a complete segment by examining the beginning and end of said segment and adding or removing adjacent content of the complete copy to form a substantially grammatically correct segment;
(viii) Providing each substantially grammatically correct segment to said user
(ix) Implementing single and multiple relevancy indices
